(19) United States
(12) Patent Application Publication
(10) Pub. No.: US 2024/0289066 A1
(43) Pub. Date: Aug. 29, 2024

(54) IMAGE FORMING APPARATUS AND METHOD FOR IMAGE FORMATION

(71) Applicant: CANON KABUSHIKI KAISHA, Tokyo (JP)

(72) Inventor: YUKIYOSHI HIKICHI, Tokyo (JP)

(21) Appl. No.: 18/582,364

(22) Filed: Feb. 20, 2024

(30) Foreign Application Priority Data
Feb. 27, 2023 (JP) 2023-027946

(51) Int. Cl. G06F 3/12

(52) U.S. Cl. CPC G06F 3/1219; G06F 3/1253

(57) ABSTRACT

An image forming apparatus includes a sheet feeding unit, a first setting unit configured to set sheet information for the sheet feeding unit, a job accepting unit configured to accept a print job, a specifying unit configured to specify the sheet feeding unit based on a setting of the accepted print job, a second setting unit configured to perform a setting to add predetermined information to the sheet information, and a notification unit configured to, in response to an instruction to execute a print job in which a sheet feeding unit to which sheet information additionally including the predetermined information is set by the first setting unit, the print job having no specific setting, notify a user of information indicating that the sheet feeding unit has been reserved.

### BACKGROUND

### Field

The present disclosure relates to an image forming apparatus and a method for image formation.

### Description of the Related Art

There is a known technique for preventing, after one user places special sheets, such as expensive paper, on one of a plurality of sheet cassettes of an image forming apparatus, another user from printing for another purpose using the sheet cassette (see Japanese Patent Laid-Open No. 2015-193087).

However, the technique disclosed in Japanese Patent Laid-Open No. 2015-193087 prevents misuse of the sheets not to be used by other users by reserving a sheet cassette that stores the sheets, and in case of forgetting to reserve the sheet cassette, the special sheets may be used for unintended printing.

### SUMMARY

To solve the above problem, various embodiments of the present disclosure reduces the possibility of forgetting to perform a setting for preventing special sheets from being printed for another unintended purpose.

An image forming apparatus according to one embodiment of the present disclosure includes a sheet feeding unit, a first setting unit configured to set sheet information for the sheet feeding unit, a job accepting unit configured to accept a print job, a specifying unit configured to specify the sheet feeding unit based on a setting of the accepted print job, a second setting unit configured to perform a setting to add predetermined information to the sheet information, and a notification unit configured to, in response to an instruction to execute a print job in which a sheet feeding unit to which sheet information additionally including the predetermined information is set by the first setting unit, the print job having no specific setting, notify a user of information indicating that the sheet feeding unit has been reserved.

An image forming apparatus according to one embodiment of the present disclosure includes a sheet feeding unit, a first setting unit configured to set sheet information for the sheet feeding unit, a job accepting unit configured to accept a print job, an execution unit configured to execute the accepted print job based on an execution instruction, a specifying unit configured to specify the sheet feeding unit based on a setting of the accepted print job, and a second setting unit configured to perform a setting to add predetermined information to the sheet information, wherein, even if an instruction to execute a print job in which a sheet feeding unit to which sheet information additionally including the predetermined information is set by the first setting unit, the print job having no specific setting, is given, the execution unit does not execute the print job.

Further features of the present disclosure will become apparent from the following description of exemplary embodiments with reference to the attached drawings.

### BRIEF DESCRIPTION OF THE DRAWINGS

FIG. 1A is a front view of an image forming apparatus.

FIG. 1B is a schematic diagram of a printer engine.

FIG. 2 is an overall view of a system including the image forming apparatus.

FIG. 3 is a diagram illustrating the details of a sheet feeding unit.

FIG. 4 is a flowchart illustrating sheet cassette reservation processing of printing processing

FIG. 5 is a diagram illustrating an example of the home screen of the image forming apparatus.

FIG. 6 is a diagram illustrating an example of the sheet setting screen of the image forming apparatus.

FIG. 7 is a diagram illustrating an example of the sheet-type setting screen of the image forming apparatus.

FIG. 8 is a flowchart illustrating an example of printer driver processing for generating a print job.

FIG. 9A is a diagram illustrating an example of a print condition setting screen displayed by driver software.

FIG. 9B is a diagram illustrating another example of the print condition setting screen displayed by the driver software.

FIG. 10 is a flowchart illustrating an example of printer processing executed by the image forming apparatus.

FIG. 11 is a flowchart illustrating an example of the details of page generation processing of the printer processing.

FIG. 12 is a flowchart illustrating an example of printing processing of the printer processing.

FIG. 13 is a flowchart illustrating an example of the details of sheet feeding determination processing of the printing processing.

FIG. 14 is a diagram illustrating an example of the no-optimum-sheet error screen of the image forming apparatus.

FIG. 15 is a diagram illustrating an example of the sheet-type setting screen of the image forming apparatus.

FIG. 16 is a diagram illustrating an example of the sheet detailed edition screen of the image forming apparatus.

FIG. 17 is a diagram illustrating an example of the sheet reservation status selection screen of the image forming apparatus.

FIG. 18 is a diagram illustrating an example of the sheet detailed edition screen of the image forming apparatus.

FIG. 19 is a flowchart illustrating an example of sheet feeding determination processing of the printing processing.

FIG. 20 is a flowchart illustrating an example of sheet setting processing executed by the image forming apparatus.

FIG. 21 is a diagram illustrating an example of the sheet setting screen of the image forming apparatus.

FIG. 22 is a diagram illustrating an example of a print condition setting screen displayed by the driver software.

FIG. 23 is a flowchart illustrating an example of processing performed by the printer driver for generating a sheet type list.

### DESCRIPTION OF THE EMBODIMENTS

Various embodiments of the present disclosure will be described in detail hereinbelow with reference to the drawings. It is to be understood that the following embodiments do not limit the present disclosure according to the claims and that not all of the combinations described in the described embodiments are required for the solution of each embodiment of the present disclosure.

### First Embodiment

An image forming apparatus according to an embodiment of the present disclosure will be described hereinbelow with reference to the drawings. The image forming apparatus includes a printer, a copying machine, a facsimile, and a compound machine having these functions and has a function for printing images on sheets serving as printing media (printing function).

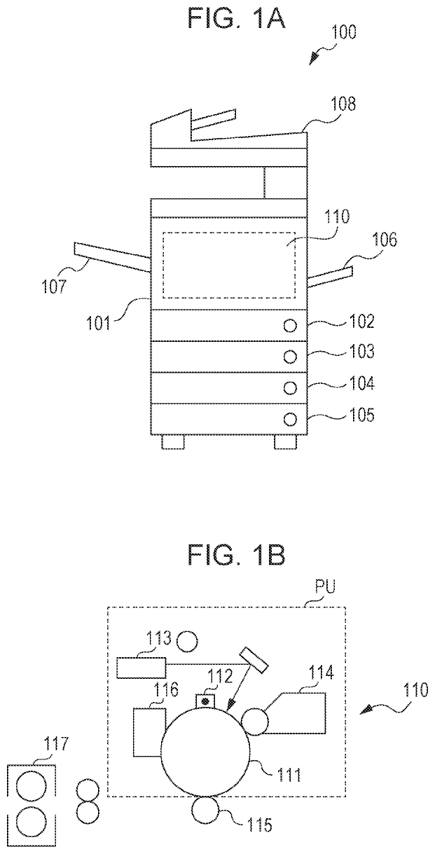

An image forming apparatus 100 illustrated in FIG. 1A is a compound machine that forms images on sheets. The sheets include paper, envelope paper, plastic films such as sheets for overhead projectors (OHPs), and cloth. The terms “paper” and “sheet” used in the drawings, etc. refer to sheets (general) including sheets other than paper unless otherwise specified.

The image forming apparatus 100 includes a printer unit 101, a scanner unit 108, a plurality of sheet cassettes 102, 103, 104, and 105, a manual feed tray 106, a discharge tray 107, and other devices. The sheet cassettes 102, 103, 104, and 105 and the manual feed tray 106 are each hereinafter referred to as a sheet cassette unless otherwise specified.

The scanner unit 108 serving as an image reading unit optically scans a document and converts the document to electronic image information using, for example, a charge coupled device (CCD) photoelectric transducer. The printer unit 101 forms an image on a sheet based on image information input from the scanner unit 108 or an external host computer with a printer engine 110, which is an example of an image forming unit. The sheet cassettes 102 to 105 contain sheets. The manual feed tray 106 supports the sheets placed thereon. The sheets held in the sheet cassettes 102 to 105 and the manual feed tray 106 are fed to the printer engine 110 while being separated one by one by a sheet feeding unit (not illustrated). The sheet cassettes 102 to 105 and the manual feed tray 106 are examples of a sheet cassette that holds sheets to be supplied to the image forming unit. The sheets on which images are formed by the printer engine 110 are discharged to the discharge tray 107 serving as a discharger.

The printer engine 110 includes an electrophotographic image forming unit PU as illustrated in FIG. 1B. The image forming unit PU includes a photosensitive drum 111 which is a drum photoconductor, a charging unit 112, an exposure unit 113, a developing unit 114, and a cleaning unit 116. In response to a request to start an image forming operation to the printer engine 110, the charging unit 112 uniformly charges the surface of the photosensitive drum 111, and the exposure unit 113 scans the photosensitive drum 111 with laser light to form an electrostatic latent image on the surface of the photosensitive drum 111. The developing unit 114 supplies charged toner to the photosensitive drum 111 to develop the electrostatic latent image to a toner image. The toner image carried by the photosensitive drum 111 is transferred to the sheet by a transfer unit 115. The toner image transferred to the sheet is fixed to the sheet by a fixing unit 117 that uses a thermal fusing method, for example.

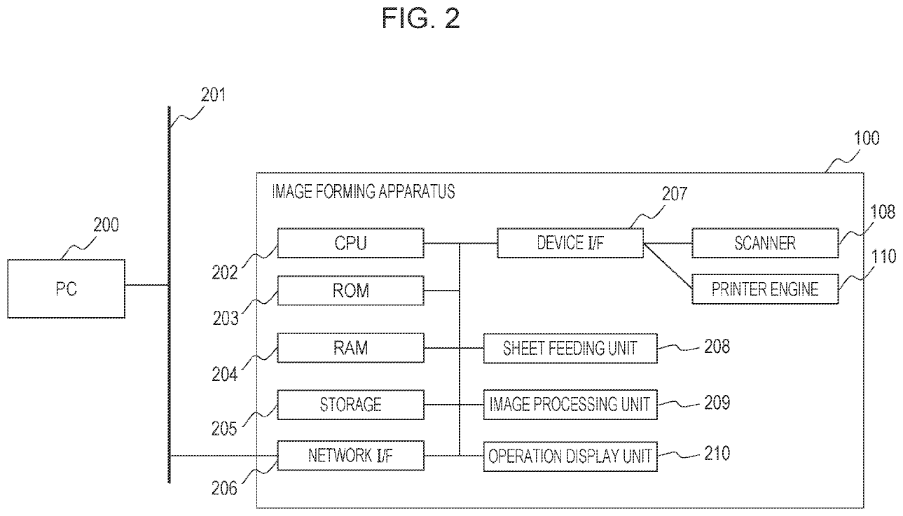

Referring next to FIG. 2, an image forming system including the image forming apparatus 100 will be described.

The image forming apparatus 100 connects to a wired or wireless network via a network interface (I/F) 206 to communicate with an information processing unit, such as a personal computer (PC) 200.

The PC 200 has a printer driver as driver software for generating a job to instruct the image forming apparatus 100 to form an image (hereinafter referred to as a print job). The printer driver generates a print job described in a page-description language (PDL) based on document data received from, for example, a document creating application of the PC 200. The PDL is an abbreviation of page-description languages, for example, post script (PS), a printer control language (PCL), and an LBP image processing system (LIPS)®. The PC 200 includes a control unit, such as a central processing unit (CPU), and storage units, such as a read-only memory (ROM), a random access memory (RAM), and a hard disk drive (HDD). The printer driver transmits the generated print job to the image forming apparatus 100 over the network.

The image forming apparatus 100 is controlled by the CPU 202, and the CPU 202 operates based on programs stored in the RAM 204. The ROM 203 is a boot ROM and stores a system boot program. The storage 205 stores system software, image data, and programs for controlling the operation of the image forming apparatus 100. The programs stored in the storage 205 are loaded on the RAM 204, and the CPU 202 controls the operation of the image forming apparatus 100 based on the programs. In the following description, the individual steps of the control process of the image forming apparatus 100 are executed by the CPU 202 unless otherwise specified.

An image processing unit 209 performs image processing on image data received via the network I/F 206 or on image data input to/output from a device I/F 207. The image data transmitted from the PC 200 is converted to raster image data by the image processing unit 209 and is stored in the storage 205. The stored image data is transmitted as a video signal to the printer engine 110 via the device I/F 207 and is used for an image forming operation performed by the printer engine 110.

The image forming apparatus 100 further includes an operation display unit 210 serving as a display unit that displays information to the user or an input unit that receives instructions from the user. The operation display unit 210 includes a screen display section including a display such as a liquid crystal display (LCD), a touch panel that is disposed on the display and that functions as a softkey from the positional relationship with an operation target displayed on the display, and an operation input section including a hardkey such as a numerical keypad.

The CPU 202 of the image forming apparatus 100 controls a sheet feeding unit 208 including sheet cassettes including the sheet cassettes 102 to 105 and the manual feed tray 106. The details of the sheet feeding unit 208 will be described later.

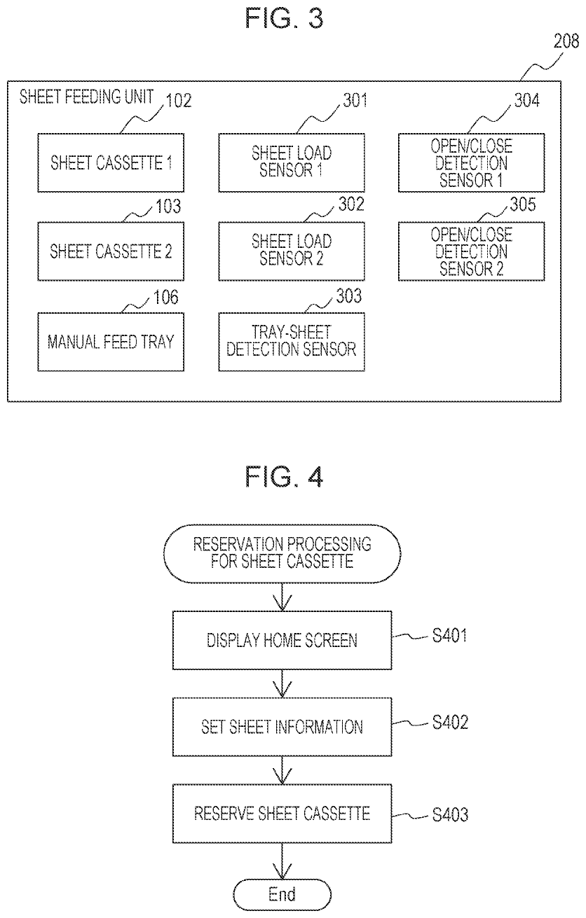

FIG. 3 is a functional block diagram illustrating the details of the sheet feeding unit 208 of the image forming apparatus 100. The sheet feeding unit 208 supplies sheets to the printer engine 110. The CPU 202 controls the sheet cassettes 1 (102) to 4 (105) and the manual feed tray 106 in the sheet feeding unit 208 to feed sheets from the sheet cassette 102 or 103 or the manual feed tray 106. The sheet cassettes 102 and 103 include sheet load sensors 301 and 302, respectively, that detect how many sheets are placed thereon. This allows the CPU 202 to detect that no sheet is placed on the sheet cassettes or the number of sheets, if placed, in the range of several levels. The sheet cassettes 102 and 103 further include open/close detection sensors 304 and 305, respectively, for detecting the open/close state of the sheet cassettes 102 and 103. This allows the CPU 202 to detect that the sheet cassettes 102 and 103 are opened or closed as an event from the open/close detection sensors 304 and 305 in real time. Each of the sheet cassette 3 (104) and the sheet cassette 4 (105) also includes a sheet load sensor and an open/close detection sensor (not illustrated in FIG. 3).

The manual feed tray 106 includes a tray-sheet detection sensor 303 that detects whether sheets are placed on the tray. The allows the CPU 202 to detect that sheets are placed on the manual feed tray 106 or removed therefrom as an event from the tray-sheet detection sensor 303 in real time.

### Processing Procedure of Image Formation

A processing procedure for executing image formation in this embodiment will be described. Although this embodiment describes sheet type reservation processing, sheet cassette reservation processing will be described first for comparison with a conventional function.

Sheet cassette reservation processing is performed before execution of image formation. The sheet cassette reservation is a setting for limiting the usage of the sheet cassettes and the manual feed tray on which sheets to be used for image formation are placed. The details will be described later. Thereafter, the PC 200 generates a print job by printer driver processing and outputs the print job to the image forming apparatus 100.

When the print job is input to the image forming apparatus 100, the image forming apparatus 100 executes printer processing to process the print job. The details of the processes will be described.

### Reservation of Sheet Cassette

The sheet cassette reservation processing will be described along the flowchart in FIG. 4. Here, the description is made on the assumption that the user places the following special sheets on the sheet cassette 102 and reserves the special sheets.
Sheet Size: A4
Sheet Type: Coated paper

First, the user places the special sheets on the sheet cassette 102. Next, the user operates the operation display unit 210 of the image forming apparatus 100 to set the sheet size and type for the sheet cassette 102.

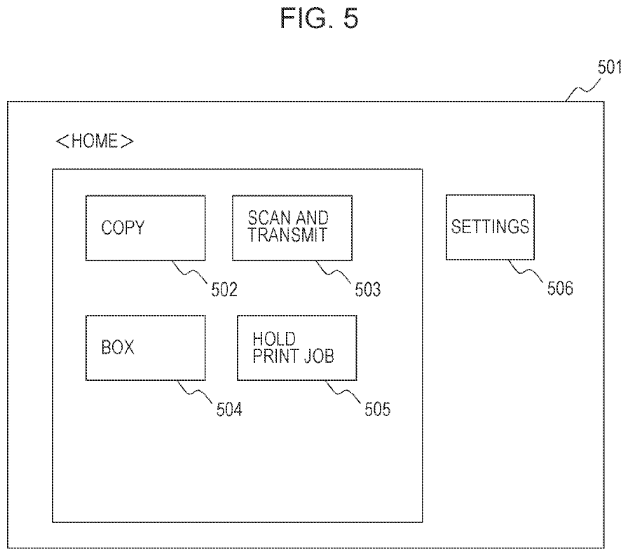

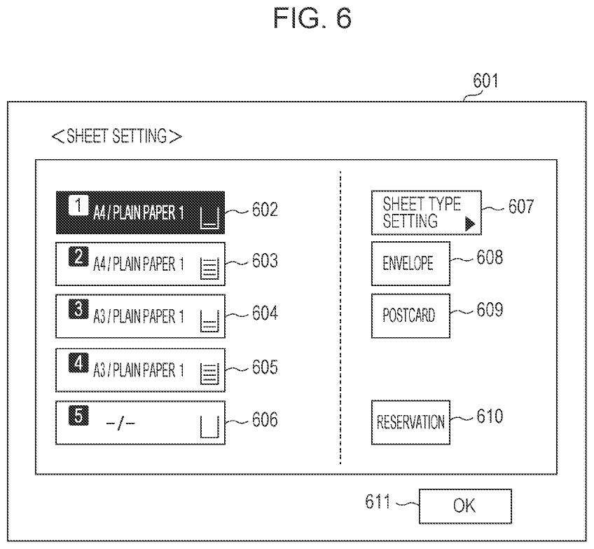

The CPU 202 of the image forming apparatus 100 displays a home screen 501 illustrated in FIG. 5 on the operation display unit 210 and waits for an operation from the user (S401). The home screen 501 displays a button 502 to select when using a copy function, a button 503 to select when using a transmitting function, and a button 504 to select when using a box function. A setting button 505 is a button to select when using the function of holding the print job. A button 506 is a button for use in various settings for the image forming apparatus 100. This setting button 506 is pressed also in setting the size and type of the sheets the user placed and reserving a sheet cassette. When the CPU 202 of the image forming apparatus 100 detects that the setting button 506 has been pressed, the CPU 202 displays a screen for selecting various setting items (not illustrated). When the CPU 202 detects that a button for sheet setting among the various setting items has been pressed, the CPU 202 displays a setting screen 601 for sheet setting, illustrated in FIG. 6 (S402). The sheet setting screen 601 displays sheet-cassette selection buttons 602 to 606, each of which displays the setting status of each sheet cassette. The details of display will be described later. The sheet setting screen 601 further displays a button 607 for changing the sheet type, buttons 608 and 609 for setting special sizes, such as envelope or postcard, as well as a reservation button 610. The setting buttons 607 to 610 are operated after one of the sheet-cassette selection buttons 602 to 606 is selected.

The details of the display of the setting status of the sheet cassettes will be described. The setting statuses of the sheet cassettes are held as sheet cassette information in the storage 205 of the image forming apparatus 100 as in Table 1. Sheet size 3002 in the table shows sizes automatically detected when sheets are placed on the individual sheet cassettes or set by the user. Sheet type 3003 is set using the button 607. Remaining sheet amount 3004 shows the remaining amounts detected by the individual sheet cassettes in five levels. Reservation status 3005 in the table shows the reservation statuses of the sheet cassettes. When the reservation button 610 is selected after a specific button is selected from the sheet-cassette selection buttons 602 to 606, a cassette corresponding to the specific button is set to “reserved” state. In the example in Table 1, the entire column of the reservation status is in blank, so that anyone can use the cassettes (nor reserved).

TABLE 1
Setting Status of Sheet Cassettes

| Sheet | Sheet | Sheet | Remaining | |
|---|---|---|---|---|
| Cassette | Size | Type | Amount of | Reservation |
| 3001 | 3002 | 3003 | Sheets 3004 | Status 3005 |
| Manual Feed | Unset | Unset | 0% | — |
| Tray 106 | | | | |
| Sheet | A3 | Plain | 100% | — |
| Cassette 105 | | paper 1 | | |
| Sheet | A3 | Plain | 50% | — |
| Cassette 104 | | paper 1 | | |
| Sheet | A4 | Plain | 100% | — |
| Cassette 103 | | paper 1 | | |
| Sheet | A4 | Plain | 25% | — |
| Cassette 102 | | paper 1 | | |

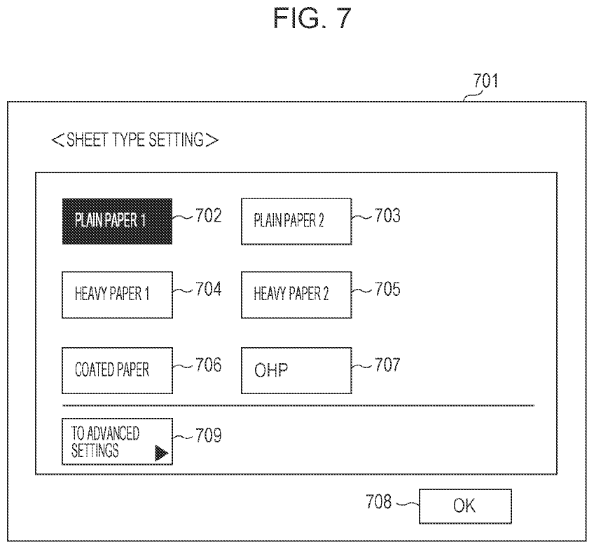

Next, an operation when one sheet cassette is selected (here, assuming that the sheet-cassette selection button 602 corresponding to the sheet cassette 102 is selected for illustrative purpose), and the button 607 is pressed will be described. In response to detecting that the button 607 is pressed, the CPU 202 of the image forming apparatus 100 displays a sheet type setting screen 701 illustrated in FIG. 7 on the operation display unit 210. The CPU 202 obtains the sheet type set for the selected sheet cassette (here, the sheet cassette 102) from the sheet cassette information stored in the storage 205 and displays the sheet type. FIG. 7 illustrates that plain paper 1 (702) is set. The sheet type setting screen 701 displays, in addition to the plain paper 1 (702), plain paper 2 (703), heavy paper 1 (704), heavy paper 2 (705), coated paper (706), and overhead transparency film (OHP) (707). The user selects a sheet type and presses an OK button 708. Then, the CPU 202 detects the pressing on the OK button 708 and updates the sheet cassette information to complete the setting of the sheet type. To-advanced-settings button 709 will be described later.

The home screen 501, the setting screen 601, and the setting screen 701 may be displayed on the operation display unit 210 of the image forming apparatus 100, or alternatively, displayed on the display of the PC 200 connected to the image forming apparatus 100 via the network 201. In this case, the screens are displayed on the display of the PC 200 by the Web server of the image forming apparatus 100 transmitting hypertext makeup language (HTML) data to the PC 200.

Next, an operation for reserving a sheet cassette will be described. The sheet cassette 102 is reserved here for illustrative purposes. When the CPU 202 of the image forming apparatus 100 detects that the reservation button 610 has been pressed, with the sheet-cassette selection button 602 corresponding to the sheet cassette 102 selected, “reserved” is recorded in the reservation status field of the sheet cassette information stored in the storage 205 (S403). This allows the sheet cassette 102 to feed sheets only in a job set to use a reserved sheet cassette in S805, described later. The reservation is cancelled by pressing the reservation button 610 again, in which case the reservation status field of the sheet cassette information stored in the storage 205 is cleared. A specific sheet feeding operation on the reserved sheet cassette will be described later in sheet feeding determination processing. When an OK button 611 is selected, the setting is confirmed.

The setting statuses of the sheet cassettes after the sheet type has been changed and the reservation processing has been performed are shown in Table 2.

The items in bold face are items changed from Table 1. This shows that the sheet type “coated paper” assigned to the sheet cassette 102 is reserved by selecting the reservation button 610.

TABLE 2
Setting Status of Sheet Cassettes

| Sheet | Sheet | Sheet | | Reservation |
|---|---|---|---|---|
| Cassette | Size | Type | Remaining Amount | Status |
| 3001 | 3002 | 3003 | of Sheets 3004 | 3005 |
| Sheet | A4 | Coated | 25% | Reserved |
| Cassette 102 | | paper | | |
| Sheet | A4 | Plain | 100% | — |
| Cassette 103 | | paper 1 | | |
| Sheet | A3 | Plain | 50% | — |
| Cassette 104 | | paper 1 | | |
| Sheet | A3 | Plain | 100% | — |
| Cassette 105 | | paper 1 | | |
| Manual Feed | Unset | Unset | 0% | — |
| Tray 106 | | | | |

### Printer Driver Processing

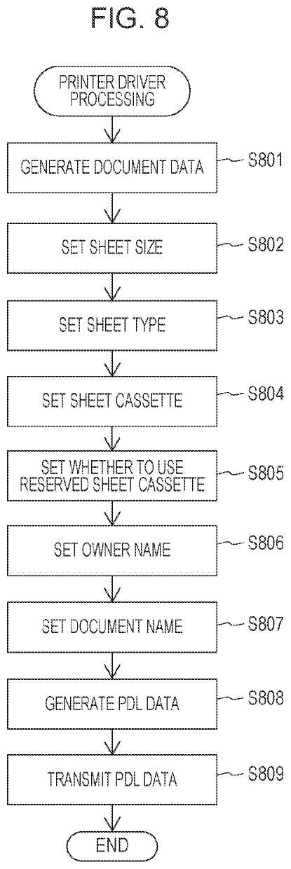

Next, the printer driver processing will be described with reference to the flowchart in FIG. 8. The following processes are achieved by the control unit, such as a CPU, of the PC 200 executing programs constituting the printer driver. The printer driver processing is started when an operation to instruct, for example, a document creation application, to execute printing is performed by the user of the PC 200. Document data indicating the details of the print (a document, a figure, etc.) is generated in advance (S801) using a document creation application or the like.

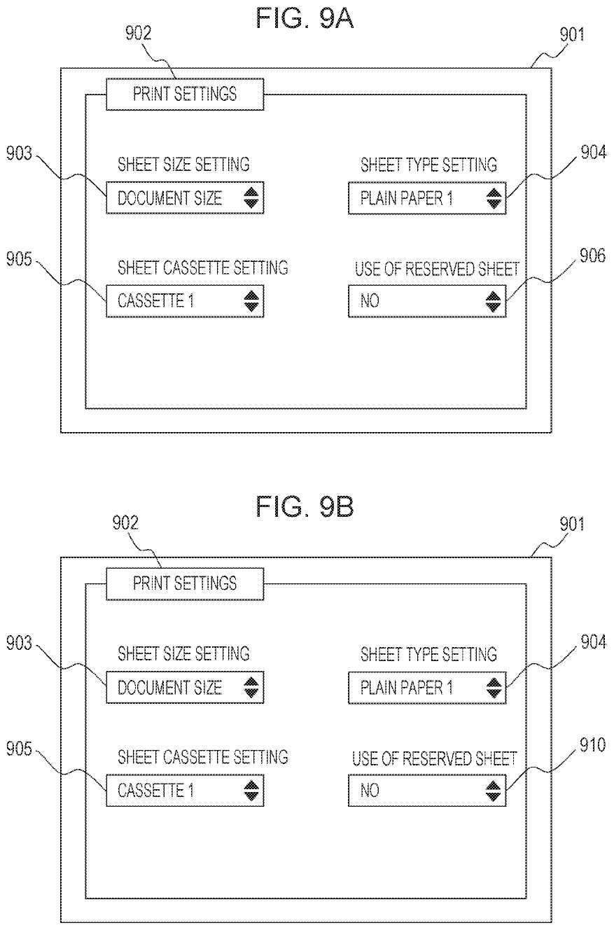

Setting processing for setting attribute information for the print job is performed based on a user operation signal to the PC 200 (S802 to S805). Specifically, as illustrated in FIG. 9A, a print setting screen 901 for setting print conditions is displayed on the display of the PC 200 to accept the user's operation. A tab 902 displays that the screen is a print setting screen. A sheet size setting field 903 displays a sheet size setting value, a sheet type setting field 904 displays a sheet type setting value, and a sheet cassette setting field 905 displays a sheet cassette specified as a sheet supply source. Selectable sheet sizes include, in addition to “document size” that is the same size as the size of document data, a standard size such as “A4”, and a user defined size that the user enters numerically. Selectable sheet types include, in addition to “plain paper 1”, “plain paper 2” having a basis weight larger than “plain paper 1”, “coated paper”, and other setting values. Selectable sheet cassettes include sheet cassettes 102 to 105 and the manual feed tray 106. For each of the sheet types and the sheet cassettes, options, such as “auto select” that leaves the selection to the image forming apparatus, may be provided. The tab 902 further displays a setting button 906 for use in setting whether to use the sheets placed on the reserved sheet cassette. By setting the setting to “Yes”, the sheets placed on the reserved sheet cassette, described later, can be used for printing.

The driver software sets information specifying the sheet size, the sheet type, and the sheet cassette serving as a sheet feeding source and the use of the reserved sheet cassette based on a user operation signal via the print setting screen 901.

Next, the printer driver sets the owner name of the print job and the document name (S806 and S807). The owner name is information for identifying the user who created the print job. In this embodiment, the owner name is the identification (ID) of the user who is currently logging in the PC 200. The document name is information for identifying the data file, such as a document or a figure to be printed, which is obtained from, for example, an application that generates the document data.

The printer driver generates PDL data conforming to the format of the PDL based on the document data and various setting information (S808). The PDL data includes page data describing what is drawn on the individual pages and print job setting information (a sheet size, a sheet type, a sheet cassette, owner name, document name, etc.). The page data is image information generated from the document data by the printer driver conforming to the PDL format. The generated PDL data is transmitted to the image forming apparatus 100 over the network 201 (S809).

### Printer Processing

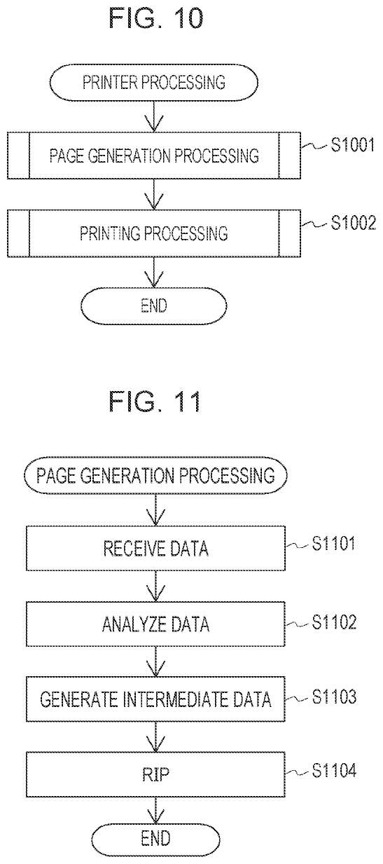

When the signal indicating the PDL data reaches the image forming apparatus 100, the CPU 202 of the image forming apparatus 100 starts printer processing. FIG. 10 is a flowchart for the printer processing.

The processes of the flowchart are achieved by the CPU 202 of the image forming apparatus 100 executing a program stored in the ROM 203 or the storage 205.

As illustrated in FIG. 10, the printer processing executes page generation processing (S1001) for generating image data roughly page by page and printing processing (S1002) for forming an image on the sheet based on the image data in sequence.

First, the details of the page generation processing will be described along the flowchart in FIG. 11. The processes of the flowchart are achieved by the CPU 202 of the image forming apparatus 100 executing a program stored in the ROM 203 or the storage 205.

The print job received from the PC 200 is temporarily stored in the storage 205 (S1101). This configuration corresponds to a job accepting unit. The print job stored in the storage 205 contains page data as the image information conforming to the PDL format. This page data is analyzed by the CPU 202 (S1102) and is converted to intermediate data (S1103). The intermediate data refers to the general term of drawing objects, such as bitmaps, run-lengths, trapezoids, boxes, and high-speed boundary-coded bitmaps, background patterns, and drawing logic for drawing raster-format images from them.

The print job setting information, such as a sheet size, contained in the PDL data is extracted through analysis with the CPU 202 and is stored in the storage 205.

The image processing unit 209 performs raster image processing (RIP) on the intermediate data and stores it in the storage 205 (S1104). The raster image processing (RIP) refers to a process for generating raster-format image data from image data such as vector images.

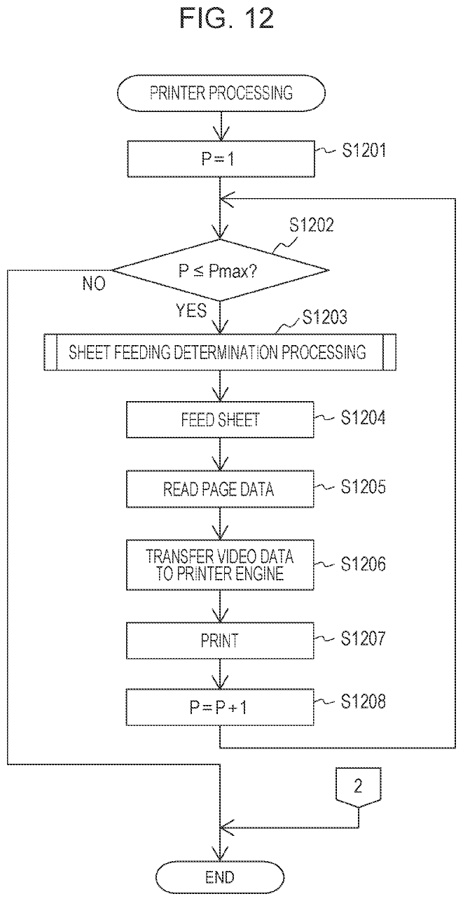

Next, the details of the printing processing will be described using the flowchart illustrated in FIG. 12. The processes of the flowchart are achieved by the CPU 202 of the image forming apparatus 100 executing a program stored in the ROM 203 or the storage 205.

When the image forming apparatus 100 starts printing processing by receiving a print job execution instruction, the CPU 202 initializes a parameter P indicating the page being processed (current sheet) (S1201). This execution instruction may be received from the PC 200 together with PDL data or may be received from the user via the operation display unit 210 of the image forming apparatus 100. The parameter P is an integer that satisfies P≥1. The CPU 202 determines whether the parameter P exceeds a variable Pmax indicating a total number of pages (the number of sheets that the print job designates) (S1202), wherein as long as P≤Pmax, the CPU 202 executes the following processes (S1203 to S1208) repeatedly. The variable Pmax is extracted through analysis of the PDL data and is stored in the storage 205.

First, the CPU 202 obtains information on the sheet cassette setting (see S804 in FIG. 8) with reference to the storage 205 and performs sheet feeding determination processing for determining whether sheets can be fed from a specified sheet cassette (S1203). The details of the sheet feeding determination processing will be described later. If it is determined by the sheet feeding determination processing that sheets can be fed, one sheet is fed (S1204). The CPU 202 reads image data on the sheet in process from the storage 205 (S1205), converts the image data to video data, and transfers the video data to the printer engine 110 (S1206). When printing processing (image forming processing) on the sheet is executed by the printer engine 110 based on the video data (S1207), the CPU 202 increments the parameter P (S1208).

When the image formation on the total number of pages (Pmax) of sheets is completed (S1202: No), the printing processing ends.

### Sheet Feeding Determination Processing

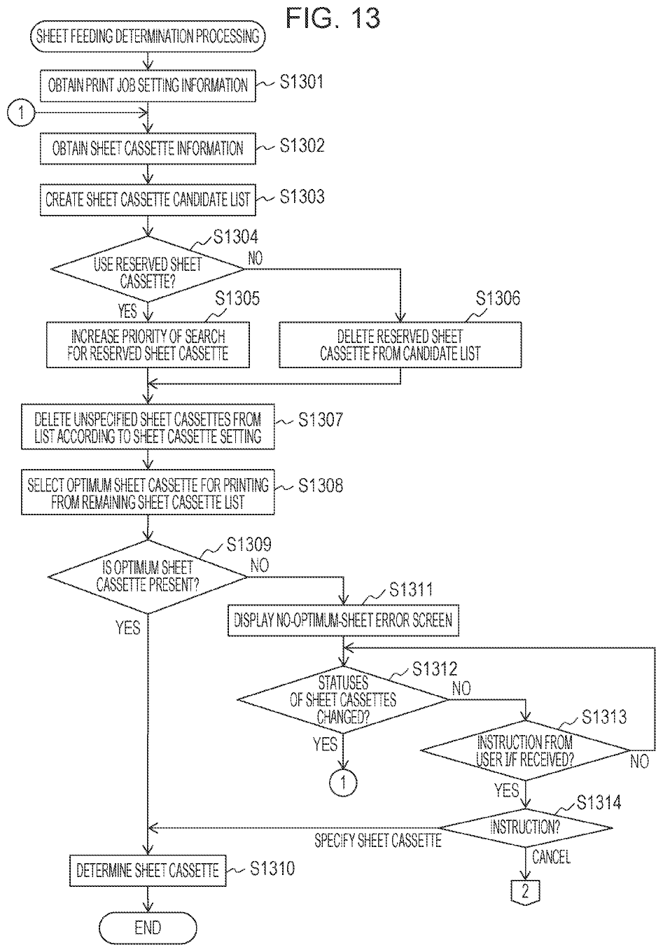

Next, the sheet feeding determination processing (S1203) will be described along the flowchart in FIG. 13. The processes of the flowchart are achieved by the CPU 202 of the image forming apparatus 100 executing a program stored in the ROM 203 or the storage 205.

In the sheet feeding determination processing, the CPU 202 first obtains the print job setting information stored in the storage 205 in S1102 (S1301). The print job setting information contains settings indicating the sheet size required for printing, the sheet type, the sheet cassette, and whether to use the reserved sheet cassette. Next, the CPU 202 obtains the sheet cassette information stored in the storage 205 (S1302). The sheet cassette information is setting information for each of the sheet cassettes shown in Table 2. The obtained sheet cassette information is duplicated to form a sheet cassette candidate list and is used to specify a sheet cassette to be used for sheet feeding in the following process (S1303).

Next in S1304, the CPU 202 switches the following operations according to the setting related to the use of the reserved sheet cassette for the print job, obtained in S1301. If the use of the reserved sheet cassette in the print job is set at “Yes”, the processing goes to S1305. In S1305, the CPU 202 rearranges the sheet cassette candidate list created in S1303 so that the “reserved” sheet cassette in the reservation status (3005) comes to the head of the list. This allows the reserved sheet cassette to be selected first in the selection of an optimum sheet cassette (S1308). In the process of S1308, not the order of precedence is rearranged, but sheet cassettes not “reserved” may be removed from the candidates.

In contrast, if the use of the reserved sheet cassette in the job is set at “No”, the processing goes to S1306, and a sheet cassette that is “reserved” in the reservation status (3005) is deleted from the sheet cassettes in the sheet cassette candidate list. For example, in the case where the reservation status of the sheet cassettes is as in Table 2, if the use of the reserved sheet cassette in the print job is set at “No”, the sheet cassette 102 is deleted from the sheet cassette candidate list. In contrast, if the use of the reserved sheet cassette in the print job is set at “Yes”, no sheet cassette is deleted from the sheet cassette candidate list. This allows the sheet cassette that is “reserved” in the reservation status (3005) to feed sheets only in a job in which the use of the reserved sheet cassette is set at “Yes”.

Next, the CPU 202 deletes the sheet cassettes other than the specified sheet cassette from the sheet cassette candidate list with reference to the sheet cassette setting information of the print job setting information obtained in S1301 (S1307).

The sheet cassette setting information is the information specified in the sheet cassette setting field 905. If a specific sheet cassette is specified in the sheet cassette setting field 905, the sheet cassettes other than the specified sheet cassette are deleted from the sheet cassette candidate list, and if auto select is set, no sheet cassettes are deleted from the sheet cassette candidate list.

Next, the CPU 202 selects an optimum sheet cassette from the sheet cassettes remaining in the sheet cassette candidate list (S1308). Specifically, the CPU 202 searches the sheet cassette candidate list from the head sheet cassette in sequence for a sheet cassette that contains sheets of a sheet size required for printing and an adapted sheet type described in the print job setting information. In S1309, the following processes are switched according to the sheet cassette search result. If the sheet cassette is found, the sheet cassette is reported to the following process (S1310), and the sheet feeding determination processing ends. The first found sheet cassette is set as the sheet cassette to be used in the job.

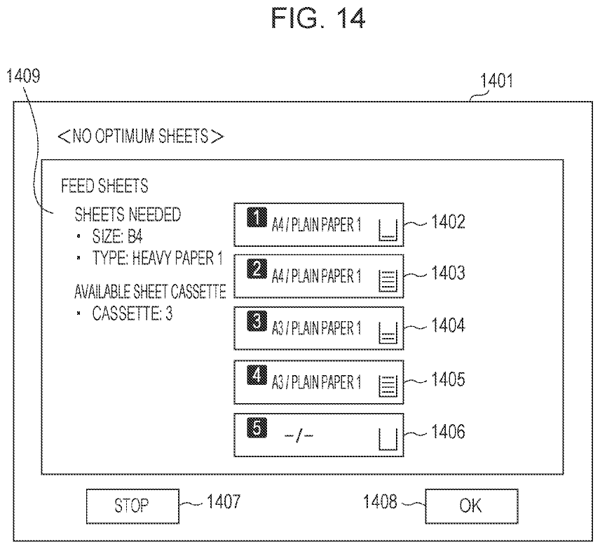

In contrast, if it is determined in S1309 that no sheet cassette is found, then in S1311 the CPU 202 displays a no-optimum-sheet error screen 1401 illustrated in FIG. 14 on the operation display unit 210 of the image forming apparatus 100. The no-optimum-sheet error screen 1401 displays a message 1409 indicating information on sheets required to continue the print job (size and type) and a sheet cassette on which the sheets can be placed. The available sheet cassette is searched for from the sheet cassette candidate list after being processed in S1307.

The error screen displayed in S1309 may be the same screen when there is no optimum sheet cassette or may be changed according to conditions. For example, if, although the use of the reserved sheet cassette in the print job is set at “No”, the sheet cassette designated in the print job is a reserved sheet cassette, information indicating that the sheet cassette specified in the job has been reserved may be displayed. At that time, the message 1409 and so on may be displayed together. If, although the use of the reserved sheet cassette in the print job is set at “No”, no sheet cassette is designated in the print job but the sheet cassette specified from the sheet size designated in the print job is only a reserved sheet cassette, another screen may be displayed. Specifically, the error screen contains a message indicating that all the sheet cassettes of the specified sheet size are reserved. Also in this case, the message 1409 and so on may be displayed together. When the use of the reserved sheet cassette in the print job is set at “Yes”, and the sheet cassette designated in the print job is a reserved sheet cassette, but no sheets are placed on the sheet cassette, the error screen 1401 in FIG. 14 may be displayed.

The operation that the user can perform when the error screen 1401 in FIG. 14 is displayed is any of the following.
Placing the sheet described in the message 1409 (in FIG. 14, B4, heavy paper 1) on the sheet cassette described in the message 1409 (in FIG. 14, cassette 3) to resolve the no-sheet error.
Pressing any of sheet-cassette selection buttons 1402 to 1406 and an OK button 1408 to forcibly continue the process for a sheet and a sheet cassette different from the sheet and the sheet cassette specified by the message 1409.
Pressing a stop button 1407 to stop the print job.

The CPU 202 waits for the user to perform any of the above operations. If there is some change in the statuses of the sheet cassettes (51312), the processing goes to S1302 because sheets may have been placed by the user, and an optimum sheet cassette is searched for again. The change in the statuses of the sheet cassettes is a change in the size of the sheets placed on a specific sheet cassette or a change in the size or type of the sheets set for the sheet cassettes.

If an instruction from the user via the operation display unit 210 is detected (S1313), the processing goes to S1314, where the processes to be performed are switched according to the instruction. If any of the buttons 1402 to 1406 is selected, the selected sheet cassette is reported to the downstream process (S1310), and the sheet feeding determination processing is terminated. In contrast, if a press to the stop button 1407 is detected, the printing processing itself is terminated.

If it is determined in S1309 that there is no optimum sheet cassette, the execution of the print job may be cancelled. This can prevent the execution of a job in which the use of a reserved sheet cassette is not designated and in which a sheet feeding unit in which the reserved sheet cassette is specified is used.

This is a method for preventing the sheets in the sheet cassette from being used for unintended use by reserving a sheet cassette. However, if the user forgets to press the reservation button 610 in FIG. 6, the sheets in the sheet cassette may be used for printing in an unintended job.

When the user stores specific sheets in a sheet cassette, the sheet type is set for the sheets to be stored in the sheet cassette. Thus, not reserving the sheet cassette itself, but reserving the sheet type for the sheet cassette can prevent forgetting to reserve the sheet cassette or printing for unintended use of even an image processing apparatus without a sheet cassette reservation function. The sheet type reservation processing will be described hereinbelow.

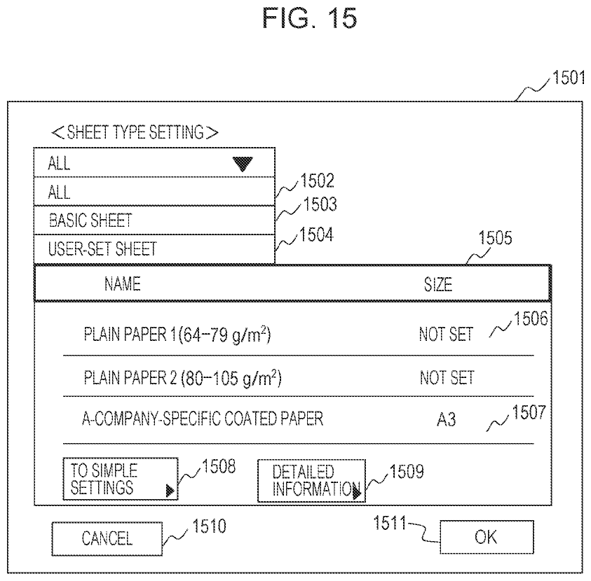

FIG. 15 illustrates an advanced settings screen 1501 for sheet type. The sheet type setting screen 701 illustrated in FIG. 7 is a simple setting screen that displays only basic sheets. The image forming apparatus 100 can create and use not only the basic sheets but a user set sheet whose attributes can be edited. When the to-advanced-settings button 709 is pressed on the simple setting screen for sheet type in FIG. 7, the sheet type advanced settings screen in FIG. 15 is displayed. A sheet type selection pulldown list is displayed at the upper left of the screen, in which an all button 1502, a basic sheet button 1503, or a user set sheet button 1504 can be selected. In the example of FIG. 15, the all button 1502 is selected, so that all sheets are displayed.

A list 1505 is a list of sheet information. The list 1505 displays the names and sizes of the items of sheet information. No size is set for plain paper 1 (1506), and “Not set” is displayed. A3-size is set for A-company-specific coated paper (1507). When a button 1508 is selected, the setting screen 701 in FIG. 7 is displayed again.

The user selects sheet information to be used from the list 1505. In other words, the CPU 202 serves as a first setting unit to set the sheet information selected by the user in association with a selected sheet feeding unit. When an OK button 1511 is selected, with sheet information is selected, the sheet information is registered as sheet information (sheet type) for the designated sheet cassette. When a cancel button 1510 is selected, the setting is cancelled.

A-company-specific coated paper (1507) is a user set sheet. This is created by duplicating and editing the basic sheet with a sheet management setting screen (not illustrated). The details of the individual sheet types can be displayed by pressing a detailed information button 1509. Each sheet type has individual attributes. The image forming apparatus 100 stores the attributes of the sheet types in the storage 205. The example in Table 3 lists the attributes of one user set sheet.

TABLE 3
Example Attributes of Sheet Type

| | Setting | | Change |
|---|---|---|---|
| Attribute Name | Value | Setting Range | Permitted |
| Name | A-company- | Any character | Yes |
| | specific | | |
| | coated paper | | |
| Type | User set | User set sheet/basic | No |
| | sheet | sheet | |
| Basis Weight | 128 g/m² | 64-128 g/m² | Yes |
| Size | A3 | A5-A3 | Yes |
| Surface Nature | High-quality | High-quality paper, | Yes |
| | paper | Coated paper, | |
| | | Recycled paper, etc. | |
| Reservation | Reserved | Reserved/Not | Yes |
| Status | | reserved | |
| Toner Amount | Off | OFF/ON | Yes |
| Adjustment Mode | | | |
| Saddle Stitch | 0.00 mm | Any value | Yes |
| Position | | | |
| Adjustment | | | |

The sheet information also contains a name to be displayed as sheet type, attributes such as sheet size and surface nature, and an adjustment value for use in printing, such as a saddle stitch position adjustment value. The attributes include reservation status, which is used to limit usage of the sheet to be used for image formation according to the sheet type. The attributes are changed via a detailed edition screen.

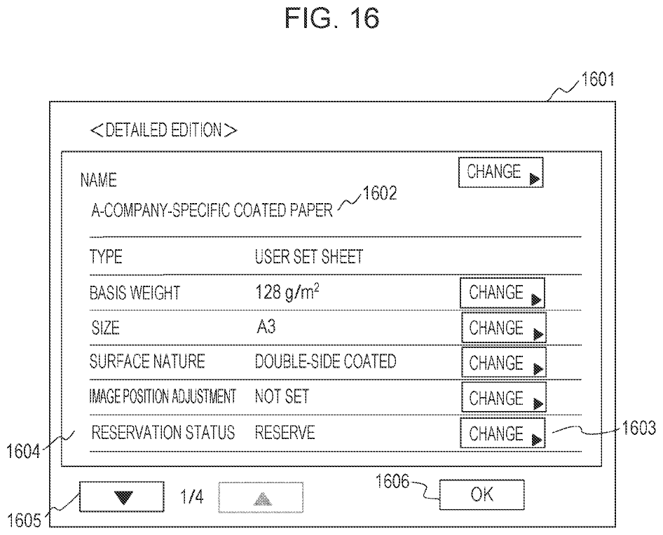

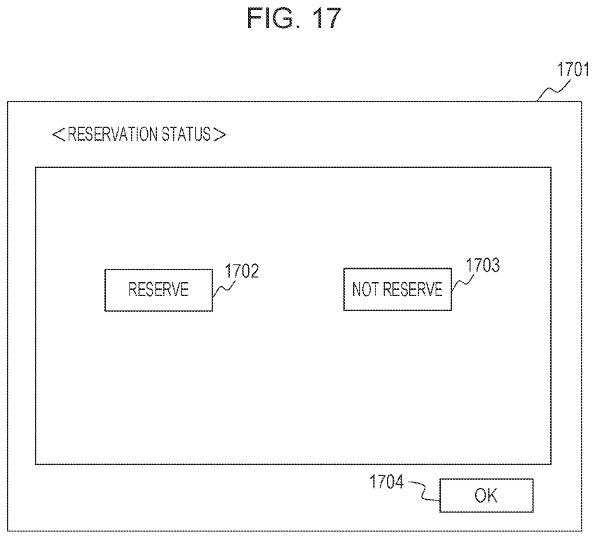

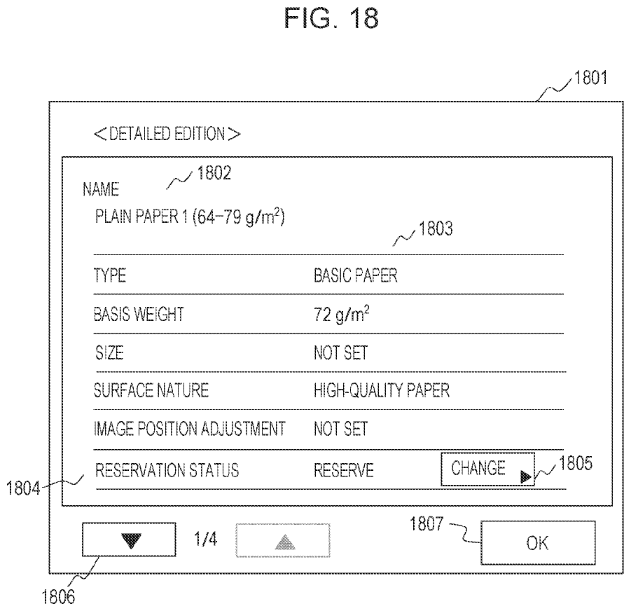

FIG. 16 is a diagram illustrating an example of a detailed edition screen 1601 for “A-company-specific coated paper”. The detailed edition screen 1601 displays the name 1602 of the sheet information. This screen allows checking the attributes of the user set sheet. The attributes can be changed by pressing a change button 1603. One of the attributes of the sheet is a reservation status 1604. When the change button 1603 is pressed, the screen shifts to a screen for changing the attribute. When a button 1605 is selected, setting information not displayed can be checked. When an OK button 1606 is selected, the settings are confirmed.

FIG. 17 is a diagram illustrating an example of a reservation status selection screen. When a “reserve” button 1702 is selected, the reservation status of the user set sheet is rewritten to “reserve”. In other words, the CPU 202 serves as a second setting unit to perform a setting for adding predetermined information “reserve” to the selected sheet information via this selection screen 1701. The sheet whose reservation status is designated as “reserve” is protected so as not to be printed when the print job does not have specific permission. When a “Not reserve” button 1703 is selected, information “Not reserve” is added to the sheet information. When an OK button 1704 is selected, the settings are confirmed.

The reservation status attribute can also be designated when a basic sheet such as “plain paper 1” is to be used. FIG. 18 is a diagram illustrating an example of a detailed edition screen 1801 for a basic sheet “plain paper 1”. A name field 1802 displays “plain paper 1 (64-79 g/m²)”. The attributes of the basic sheet are not editable, so that no change buttons are present in an attribute display field 1803. However, only a reservation status field 1804 can be changed in attribute. A change button 1805 is displayed only for this item. When the change button 1805 is pressed, the selection screen 1701 in FIG. 17 is displayed for selection. Pressing the button 1702 to make a reservation and the button 1703 not to make a reservation allows specifying whether a reservation is required to use the sheet. Thus, a user who uses only a basic sheet can specify the reservation status for the sheet to be used. When a button 1806 is selected, setting information not displayed can be checked.

The print setting screen of the printer driver can also be changed as in FIG. 9B. Since the sheet type is to be reserved, not the sheet cassette, the setting item at the lower right in the screen is “Use of reserved sheet”. Whether to transmit a print job including a specific setting to use a reserved sheet (a sheet feeding unit in which sheet information additionally including information indicating that the sheet is reserved is set) can be selected using a setting button 910. The other items are the same as in FIG. 9A.

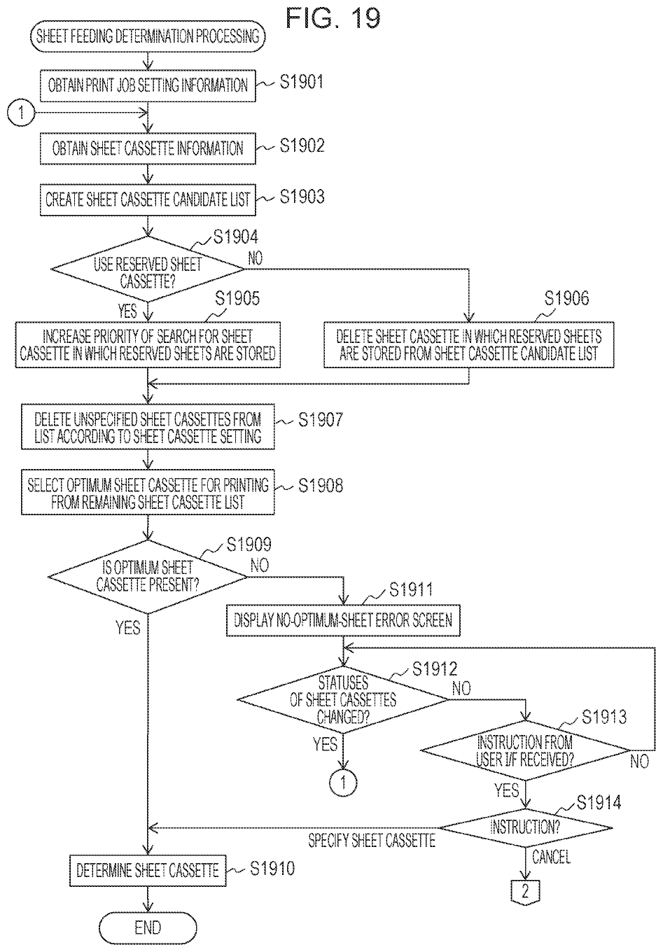

The sheet feeding determination processing (S1203) in printing in which the sheet type is given a reservation attribute will be described with reference to the flowchart in FIG. 19. The processes of the flowchart are achieved by the CPU 202 of the image forming apparatus 100 executing a program stored in the ROM 203 or the storage 205.

Since the processes from S1901 to S1903 executed by the CPU 202 are the same as the processes when the sheet cassette is given a reservation setting in FIG. 13, descriptions will be omitted.

The CPU 202 switches the following operations according to the details of the setting for the use of the reserved sheet for the print job (S1904). If the use of the reserved sheet is set at “Yes” in the print job, the processing goes to S1905. In S1905, the CPU 202 rearranges the sheet cassette candidate list created in S1903 so that a sheet cassette whose reservation status of the sheet type assigned to the sheet cassette is “reserve” comes to the head of the list. This allows the reserved sheet cassette to be selected first in the selection of an optimum sheet cassette (S1908) described later. In the process of S1908, not the order of precedence is rearranged, but sheet cassettes not “reserved” may be removed from the candidates.

In contrast, if the use of the reserved sheet in the job is set at “No”, the processing goes to S1906, where a sheet cassette whose sheet type reservation status assigned to the sheet cassette is “reserve” is deleted from the sheet cassettes in the sheet cassette candidate list. For example, in the case where the sheet cassette reservation status is as in Table 4, if the print job is configured not to use a reserved sheet cassette, the sheet cassette 102 is deleted from the sheet cassette candidate list. If the print job is configured to use a reserved sheet, no sheet cassette is deleted from the sheet cassette candidate list. This allows a sheet cassette in which the reservation status of the assigned sheet type is “reserve” to feed sheets only in a job in which the use of the reserved sheet is set at “Yes”.

For example, if the use of the reserved sheet in the print job is set at “No” in the setting status as in Table 4, and the sheet cassette 102 is selected as the sheet feeding source, the processing goes to S1911, resulting in no-sheet error (sheet mismatch error). In other words, since a specific instruction (to use the reserved sheet) is not given by the printer driver although a reserved sheet is set for the specified sheet cassette, an error occurs. This allows preventing using special sheets in executing a normal job in which a specific instruction (to use a reserved sheet) is not given by the printer driver. Reservation of a sheet cassette can be made only by setting sheet types for sheet cassettes without the need for the user to make an individual sheet cassette reservation process. Furthermore, sheet information set for the reserved sheet in advance can be used also for other sheet cassettes. This allows reservation of a plurality of sheet cassettes only by giving one sheet reservation instruction and setting a sheet type for each sheet cassette. For example, setting A-company-specific coated paper for the sheet cassettes 102 and 103 allows both of the sheet cassettes 102 and 103 to be brought into a reservation status. This can reduce the time and effort in bringing multiple sheet cassettes into a reservation status.

TABLE 4
Setting Status of Sheet Cassettes

| | | | Remaining | Sheet Type |
|---|---|---|---|---|
| Sheet | Sheet | | Amount of | Reservation |
| Cassette | Size | Sheet Type | Sheets | Status |
| Sheet | A3 | A-company- | 25% | Reserved |
| Cassette 102 | | specific coated | | |
| | | paper | | |
| Sheet | A4 | Plain paper 1 | 100% | Not reserved |
| Cassette 103 | | | | |
| Sheet | A3 | Plain paper 1 | 50% | Not reserved |
| Cassette 104 | | | | |
| Sheet | A3 | Plain paper 1 | 100% | Not reserved |
| Cassette 105 | | | | |
| Manual Feed | Unset | Unset | 0% | — |
| Tray 106 | | | | |

Since the processes from S1907 to S1914 are the same as the processes when the sheet cassette is given a reservation setting in FIG. 13, descriptions will be omitted.

The above processing prevents executing a job in which the use of a reserved sheet is not designated and which uses a reserved sheet type. Thus, giving the sheet information a reservation status attribute prevents the use of sheets in unintended printing.

### Second Embodiment

The first embodiment illustrates a method for preventing the use of sheets in unintended printing by giving an attribute of reservation status to sheet types stored in the image forming apparatus 100.

A second embodiment illustrates a method for, in the case in which both of sheet types and sheet cassettes have reservation settings, reserving a sheet cassette reliably in assigning a sheet type to each of sheet cassettes even if no sheet cassette is reserved.

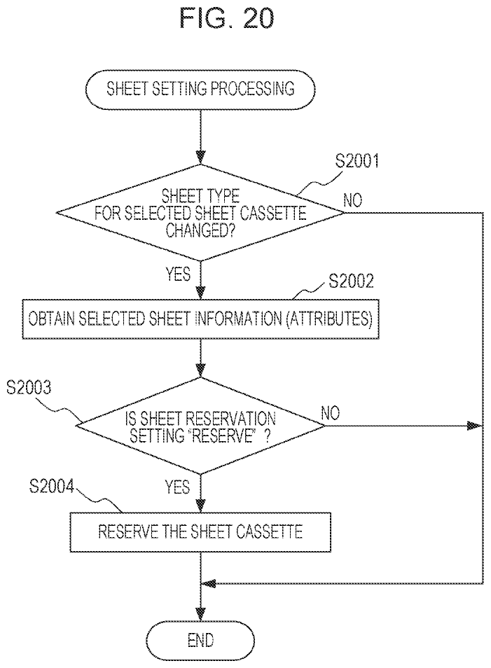

Sheet setting processing will be described along the flowchart in FIG. 20. Specifically, this is processing performed when the user assigns a sheet to each of the sheet cassettes on the sheet setting screen in FIG. 6. The processes of the flowchart are achieved by the CPU 202 of the image forming apparatus 100 executing a program stored in the ROM 203 or the storage 205.

The CPU 202 determines whether the sheet type assigned to a sheet cassette selected by the user has changed (S2001). If yes, the CPU 202 obtains the attributes of the sheet assigned to the sheet cassette (S2002). The CPU 202 further checks the value of reservation setting in the attributes (S2003). If the setting value is “reserve”, the CPU 202 executes the same process as when the reservation button 610 on the sheet setting screen in FIG. 6 is pressed to bring the sheet cassette to a reserved status (S2004).

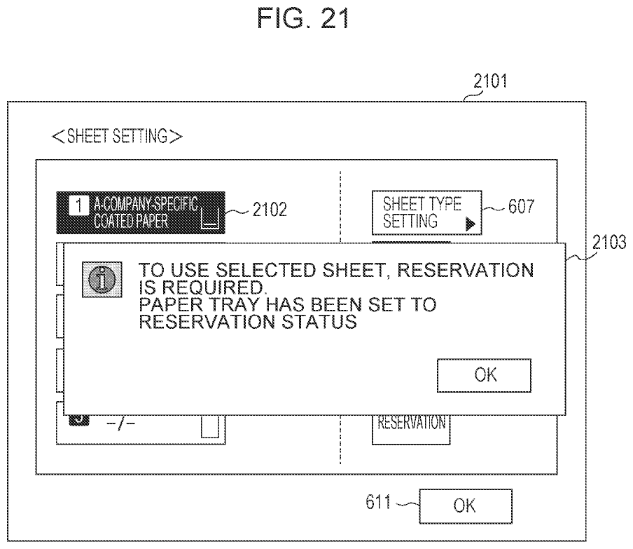

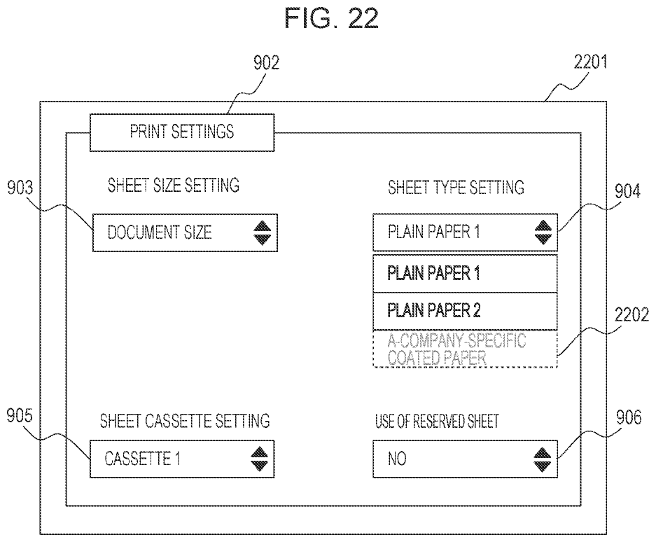

FIG. 21 is a diagram illustrating an example of a sheet setting screen. The user sets “A-company-specific coated paper” 2102 for the sheet cassette whose reservation status attribute is “reserve”. For this reason, the CPU 202 displays a dialog 2103 notifying the user of the fact the process S2004 is executed to reserve the sheet cassette on a setting screen 2101.

Thus, providing the reservation status to the sheet information in advance allows, when the user specifies a sheet for the sheet cassette at the same time or ahead of sheet change, the sheet cassette to be reliably reserved according to the reservation attribute of the specified sheet. In other words, this can prevent the sheets from being used for unintended printing more reliably.

### Third Embodiment

The first embodiment illustrates a method for reliably reserving a sheet cassette at assigning a sheet to each sheet cassette by providing a reservation status to each of the sheet information items stored in the image forming apparatus 100. A third embodiment illustrates protection processing in submitting a job from the printer driver. This prevents setting of a sheet type that does not match the use/unuse of the reserved sheet cassette in the job on the operating screen of the printer driver.

FIG. 22 illustrates a print setting screen 2201 of the printer driver. This is almost the same as the configuration of the print setting screen 901 described above. A pulldown list 2202 displayed by clicking a sheet type setting field 904 contains the user set sheet “A-company-specific coated paper” described in the first embodiment. This sheet is set to require reservation of a sheet cassette. The driver screen shows that the use of the reserved sheet cassette is set to “No”. For this reason, this print job cannot use the A-company-specific coated paper, and the pulldown list is grayed out so as not to be selected. The A-company-specific coated paper is protected so as not to be specified as the sheet type unless the user of the printer driver changes the setting for using the reserved sheet cassette. Also for the sheet cassette setting field 905, the reserved cassette is protected so as not to be selected as the sheet cassette (not illustrated).

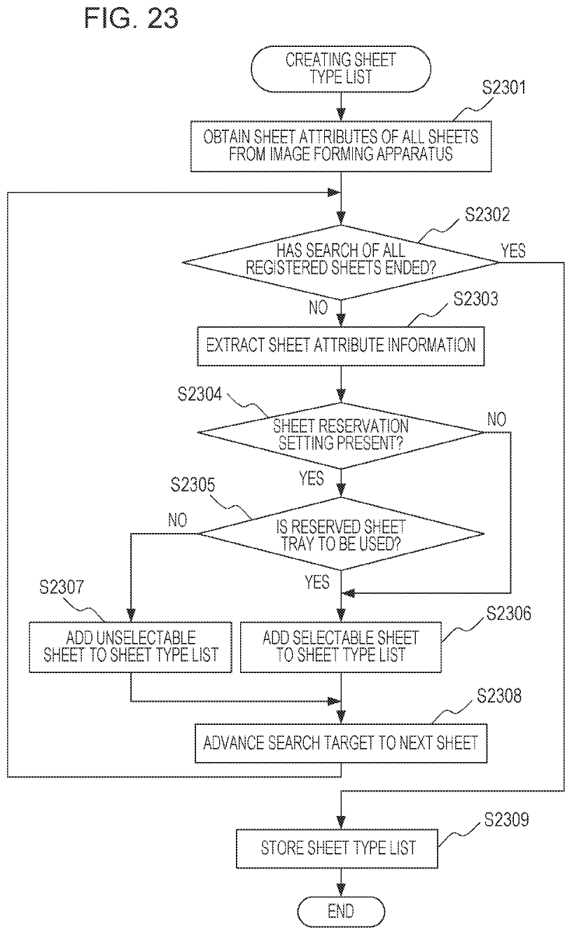

The details of processing for creating a list of sheet types will be described along the flowchart in FIG. 23. Specifically, this is processing for creating sheet type list information displayed in the sheet type setting field of the print setting screen in FIG. 22. The processes of the flowchart are achieved by the control unit, such as a CPU, of the PC 200 executing programs constituting the printer driver.

The printer driver communicates with the image forming apparatus 100 to obtain the attributes of the basic sheets and the user set sheet in the image forming apparatus 100 (S2301). The printer driver repeats the following processes for all the sheets obtained from the image forming apparatus 100 (S2302). First, the printer driver obtains the attribute information on the currently selected sheet (S2303). The printer driver determines whether the sheet has been reserved with reference to the value of the reservation status in the attributes (S2304).

If the sheet is not reserved, the sheet is available in all jobs. The printer driver adds the sheet to a sheet type list as a sheet that can be selected by the job (S2306). In contrast, if it is determined in in S2304 that the sheet is reserved, the value of the setting whether to use the reserved sheet cassette set on the print setting screen in FIG. 22 is checked (S2305). If the use of the reserved sheet cassette is set at “Yes”, the printer driver adds the sheet as a sheet that can be selected for the job to the sheet type list (S2306). If in S2305 it is determined that the reserved sheet cassette is not to be used, the printer driver adds the sheet as a sheet that cannot be selected for the job to the sheet type list (S2307). After completion of the addition to the sheet type list, the printer driver searches for another sheet (S2308). If in S2302 the printer drive determines that checking of all the sheets obtained from the image forming apparatus 100 is completed, then the printer driver stores the created sheet type list (S2309). In displaying the sheet type setting field 904 displayed on the user interface (UI) screen of the printer driver, a sheet grayout display process is performed according to the values of the created sheet type list.

Executing the above processing prevents, in submitting a job in which the use of a reserved sheet cassette is not designated, selecting a sheet that requires reservation for the job. In other words, this can prevent sheets that require reservation from being used for unintended printing. This configuration facilitates allowing the user to determine that the sheets cannot be used in submitting a print job via the printer driver, eliminating the need for unnecessary operations by submitting an erroneous job.

### OTHER EMBODIMENTS

Various embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-027946, filed Feb. 27, 2023, which is hereby incorporated by reference herein in its entirety.

What is claimed is:

1. An image forming apparatus comprising:
a sheet feeding unit;
a first setting unit configured to set sheet information for the sheet feeding unit;
a job accepting unit configured to accept a print job;
a specifying unit configured to specify the sheet feeding unit based on a setting of the accepted print job;
a second setting unit configured to perform a setting to add predetermined information to the sheet information; and
a notification unit configured to, in response to an instruction to execute a print job in which a sheet feeding unit to which sheet information additionally including the predetermined information is set by the first setting unit, the print job having no specific setting, notify a user of information indicating that the sheet feeding unit has been reserved.

2. The image forming apparatus according to claim 1, wherein the predetermined information comprises information indicating that a sheet corresponding to the sheet information is to be reserved.

3. The image forming apparatus according to claim 1, wherein the sheet information includes a sheet size and a sheet type.

4. The image forming apparatus according to claim 1, wherein the specifying unit specifies the sheet feeding unit based on a sheet size setting of the accepted print job.

5. The image forming apparatus according to claim 4, wherein the specified sheet feeding unit comprises a sheet feeding unit in which a same sheet size as the sheet size set for the print job is set.

6. The image forming apparatus according to claim 1, wherein the specific setting comprises a setting for using a reserved sheet.

7. An image forming apparatus comprising:
a sheet feeding unit;
a first setting unit configured to set sheet information for the sheet feeding unit;
a job accepting unit configured to accept a print job;
an execution unit configured to execute the accepted print job based on an execution instruction;
a specifying unit configured to specify the sheet feeding unit based on a setting of the accepted print job; and
a second setting unit configured to perform a setting to add predetermined information to the sheet information,
wherein, even if an instruction to execute a print job in which a sheet feeding unit to which sheet information additionally including the predetermined information is set by the first setting unit, the print job having no specific setting, is given, the execution unit does not execute the print job.

8. The image forming apparatus according to claim 7, wherein the predetermined information comprises information indicating that a sheet corresponding to the sheet information is to be reserved.

9. The image forming apparatus according to claim 7, wherein the sheet information includes a sheet size and a sheet type.

10. The image forming apparatus according to claim 7, wherein the specifying unit specifies the sheet feeding unit based on a sheet size setting of the accepted print job.

11. The image forming apparatus according to claim 9, wherein the specified sheet feeding unit comprises a sheet feeding unit in which a same sheet size as the sheet size set for the print job is set.

12. The image forming apparatus according to claim 7, wherein the specific setting comprises a setting for using a reserved sheet.

13. A method for image formation comprising:
setting sheet information for a sheet feeding unit;
accepting a print job;
specifying the sheet feeding unit based on a setting of the accepted print job;
performing a setting to add predetermined information to the sheet information; and
in response to an instruction to execute a print job in which a sheet feeding unit to which sheet information additionally including the predetermined information is set by the setting, the print job having no specific setting, notifying a user of information indicating that the sheet feeding unit has been reserved.

14. A method for image formation comprising:
setting sheet information for a sheet feeding unit;
accepting a print job;
executing the accepted print job based on an execution instruction;
specifying the sheet feeding unit based on a setting of the accepted print job; and
performing a setting to add predetermined information to the sheet information,
wherein, even if an instruction to execute a print job in which a sheet feeding unit to which sheet information additionally including the predetermined information is set in the setting, the print job having no specific setting, is given, the print job is not executed in the executing.
